(19) United States
(12) Patent Application Publication
(10) Pub. No.: US 2018/0060925 A1
(43) Pub. Date: Mar. 1, 2018

(54) Seller Coordination of Multiple Price Mechanisms

(71) Applicant: International Business Machines Corporation, Armonk, NY (US)

(72) Inventors: Markus Ettl, Ossining, NY (US); Shivaram Subramanian, Fairfield, CT (US); Zhengliang Xue, Yorktown Heights, NY (US)

(21) Appl. No.: 15/252,738

(22) Filed: Aug. 31, 2016

(51) Int. Cl. G06Q 30/02; G06Q 30/06

(52) U.S. Cl. CPC G06Q 30/0283; G06Q 30/0611; G06Q 30/0201; G06Q 30/0206

(57) ABSTRACT

Systems, methods, and computer-readable media are disclosed for jointly optimizing one or more parameters associated with multiple different price mechanisms. The price mechanisms may include spot market pricing, fixed-contract pricing, formula-based pricing, or the like, and may vary in duration. The optimized parameters may include an optimized price for each price mechanism that maximizes expected seller profit across all price mechanisms and all buyers.

### FIELD OF THE INVENTION

This invention relates generally to the coordination of multiple price mechanisms, and more specifically, to the coordination of price mechanisms in a dynamic market.

### BACKGROUND

A seller may apply different price mechanisms to different buyers seeking to purchase a product or service from the seller. Such price mechanisms may include, for example, spot market pricing, formula-based pricing, fixed-price contracts of a certain duration (e.g., short-term, mid-term, long-term), inventory-based list pricing, and so forth. Existing techniques for determining which price mechanism to offer to a particular buyer and what values to select for certain parameters such as price and quantity suffer from a number of drawbacks including the failure to effectively coordinate pricing across all types of price mechanisms. Technical solutions to these and other drawbacks of existing techniques are described herein.

### SUMMARY

In one or more example embodiments of the disclosure, a method is disclosed for jointly optimizing a plurality of price mechanisms. The method includes receiving, from a buyer, a quote request for purchase of a product from a seller. The method further includes forecasting a first demand for the product for a first price mechanism of the plurality of price mechanisms, and forecasting a second demand for the product for a second price mechanism of the plurality of price mechanisms that is different from the first price mechanism. The method additionally includes jointly optimizing a first one or more parameters of the first price mechanism and a second one or more parameters of the second price mechanism based at least in part on the first demand and the second demand.

In one or more other example embodiments of the disclosure, a system is disclosed for jointly optimizing a plurality of price mechanisms. The system includes at least one memory storing computer-executable instructions and at least one processor configured to access the at least one memory and execute the computer-executable instructions to perform a set of operations. The operations include receiving, from a buyer, a quote request for purchase of a product from a seller. The operations further include forecasting a first demand for the product for a first price mechanism of the plurality of price mechanisms, and forecasting a second demand for the product for a second price mechanism of the plurality of price mechanisms that is different from the first price mechanism. The operations additionally include jointly optimizing a first one or more parameters of the first price mechanism and a second one or more parameters of the second price mechanism based at least in part on the first demand and the second demand.

In one or more other example embodiments of the disclosure, a computer program product for jointly optimizing a plurality of price mechanisms is disclosed that comprises a non-transitory storage medium readable by a processing circuit, the storage medium storing instructions executable by the processing circuit to cause a method to be performed. The method includes receiving, from a buyer, a quote request for purchase of a product from a seller. The method further includes forecasting a first demand for the product for a first price mechanism of the plurality of price mechanisms, and forecasting a second demand for the product for a second price mechanism of the plurality of price mechanisms that is different from the first price mechanism. The method additionally includes jointly optimizing a first one or more parameters of the first price mechanism and a second one or more parameters of the second price mechanism based at least in part on the first demand and the second demand.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic block diagram illustrating various components of a price mechanism optimization system in accordance with one or more example embodiments of the disclosure.

FIG. 2 is a process flow diagram of a method for jointly optimizing a plurality of price mechanisms in accordance with one or more example embodiments of the disclosure.

FIG. 3 is a process flow diagram of a more detailed method for jointly optimizing a plurality of price mechanisms in accordance with one or more example embodiments of the disclosure.

FIG. 4 is a schematic depiction of joint optimization of a plurality of price mechanisms having different time periods associated therewith in accordance with one or more example embodiments of the disclosure.

FIG. 5 is a schematic diagram of an illustrative networked architecture in accordance with one or more example embodiments of the disclosure.

### DETAILED DESCRIPTION

A seller may sell a product or service to different buyers in accordance with different price mechanisms. The particular price mechanism chosen for a particular buyer may depend on a number of factors such as, for example, prior purchase history of the buyer, a risk profile of the buyer, and so forth. A variety of types of price mechanisms are available including, without limitation, spot market pricing, formula-based pricing, fixed-price contracts of a certain duration (e.g., short-term, mid-term, long-term), inventory-based list pricing, and so forth.

A spot market price mechanism, for example, does not specify a fixed price, but rather relies on a price of a product on a spot market, which may fluctuate over time. A fixed-price contract, on the other hand, specifies 1) a negotiated price at which the seller is obligated to sell a product to the buyer 2) a committed quantity (also referred to herein as a minimum committed amount) that the buyer is obligated to purchase from the seller under the contract, and 3) a contract term indicative of a period of time over which the seller is obligated to sell the product to the buyer at the negotiated price. The contract term may vary. For example, fixed-price contracts may include weekly contracts, monthly contracts, quarterly contracts, or annual contracts. Fixed-price contracts may also specify a total amount of the product that the seller is obligated to deliver to the buyer if requested by the buyer, and optionally, risk-aware terms under which the contract may be re-negotiated to accommodate any significant change in market conditions.

While the buyer is required to purchase the minimum committed amount at the negotiated price of a fixed-price contract, the buyer is free to purchase any additional needed amount at a spot market price. For instance, a price discrepancy between the spot market price and the fixed contract price (e.g., a monthly contract price) may encourage buyers to switch from the fixed-price contract and buy at the lower spot market price or negotiate a contract at a lower price with a competitor. As such, with fixed-price contracts, a buyer's total cost includes both a deterministic portion (e.g., the cost associated with purchasing the minimum committed amount at a fixed price) and a random portion that depends on the volume of product beyond the minimum committed amount that may be purchased on the spot market.

Price mechanisms other than spot market pricing and fixed-price contract pricing include, for example, inventory-based list pricing according to which a seller determines a price at which to offer a product based on inventory stock levels and/or production capacity. For example, under an inventory-based list pricing scheme, a seller may lower the price of a product if inventory levels are high (e.g., at or above some threshold level of inventory), and similarly may increase the price of a product if inventory levels are low. Another type of price mechanism is formula-based pricing which involves determining the price of a product based on a formula. The formula may include a fixed component (e.g., a constant) and another component that fluctuates based, for example, on a spot market price. The fixed component and/or the fluctuating component may be weighted by respective weighting factors. Similar to a fixed-price contract, an inventory-based price mechanism and/or a formula-based price mechanism may have a minimum committed amount associated therewith.

As previously noted, a fluctuating spot market price of a product produces uncertainty for a buyer as to when and how much of a product the buyer may obtain from the spot market beyond the minimum committed amount associated with a fixed-price contract, formula-based contract, or the like. Similarly, a fluctuating spot market price also produces uncertainty for a seller. While the minimum committed amount associated with, for example, a fixed-price contract is a stable amount for a seller, product volume beyond the minimum committed amount (which may be obtained by a buyer from the spot market or under the contract based on periodically volatile spot market prices) generates uncertainty for a seller. A seller's production costs may thus vary based on the uncertainty associated with the randomness of the uncommitted product volume. It should be appreciated that the term product may be used herein to generically refer to any good, service, or the like that may be exchanged between a seller and a buyer.

Total expected revenue for a seller is dependent on the particular price mechanisms and associated parameters selected across a group of buyers. For example, under a fixed-price contract, total expected revenue depends on a number of factors including the contract term price, the minimum committed volume, and the volume beyond commission obtained by the buyer under the contract (which in turn depends on the fluctuating spot market price). Example embodiments of the disclosure seek to maximize expected profit for a seller by jointly optimizing the price mechanisms and associated parameters offered to a group of buyers over a planning horizon, while at the same time ensuring consistency of prices between price mechanisms of different durations.

Conventional techniques for determining the price of a fixed-price contract and/or which type of price mechanism to offer to a buyer suffer from a number of drawbacks. For example, conventional techniques typically employ an ad-hoc approach to determining the price mechanism to offer to a particular buyer. Further, conventional techniques typically set and/or adjust the price associated with a price mechanism offered to a particular buyer independently of the price associated with price mechanisms offered to other buyers. Such independent pricing across price mechanisms often leads to price gaps between price mechanisms that, in turn, cause buyers to switch between price mechanisms. Switching between price mechanisms may cause volume fluctuations that lead to unstable production planning and higher manufacturing costs for sellers.

Example embodiments of the disclosure eliminate or mitigate the aforementioned and other drawbacks associated with conventional techniques by jointly optimizing price mechanisms that span different time periods. Total revenue and production cost for a seller are dependent on the collective prices associated with all price mechanisms offered to buyers. Further, a particular price mechanism may have an impact on another price mechanism. For example, a buyer's purchase behavior associated with a fixed-price contract may depend on spot market pricing for the product. In addition, different price mechanisms may have different time horizons and risk profiles associated therewith. Example embodiments of the disclosure account for these interactions between price mechanisms as part of a joint optimization of all price mechanisms across different time horizons and risk profiles.

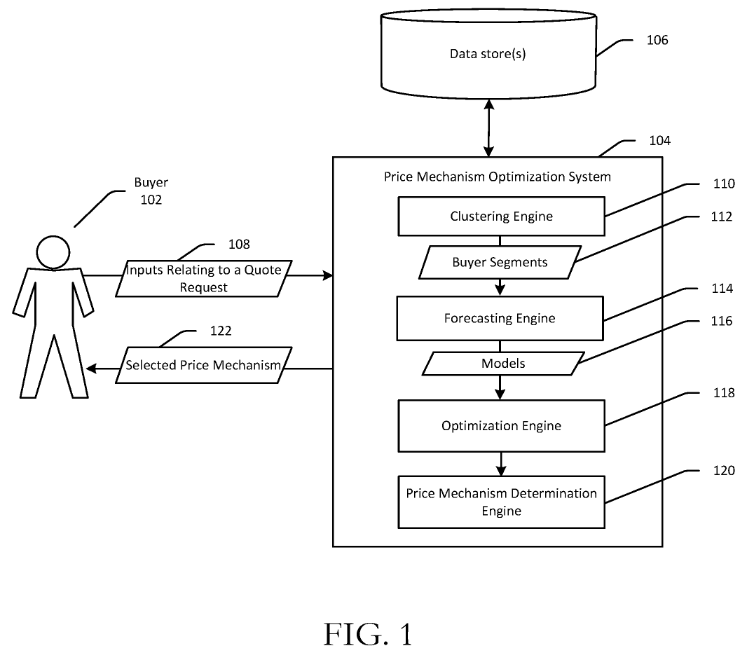

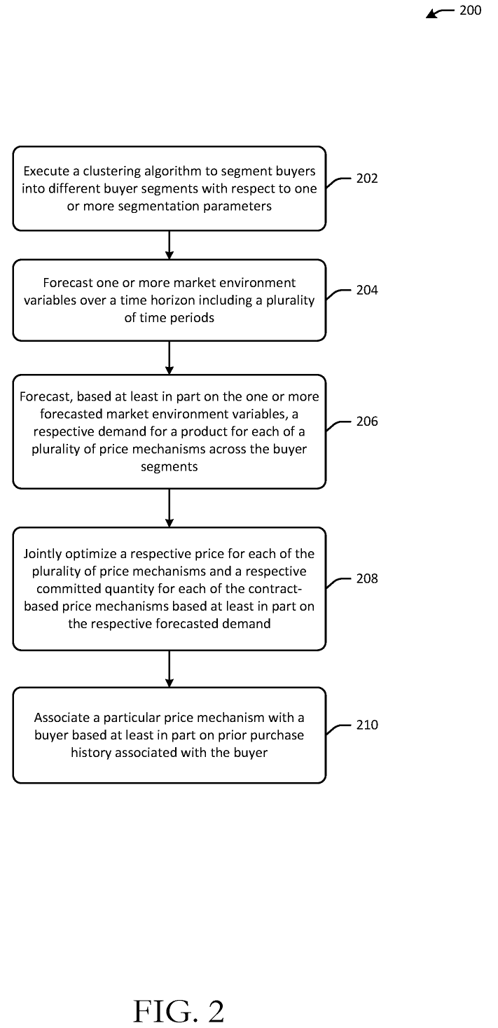

FIG. 1 is a schematic block diagram illustrating various components of a price mechanism optimization system 104 in accordance with one or more example embodiments of the disclosure. FIG. 2 is a process flow diagram of a method 200 for jointly optimizing a plurality of price mechanisms in accordance with one or more example embodiments of the disclosure. FIGS. 1 and 2 will be described in conjunction with one another hereinafter.

One or more operations of the method 200 may be performed by one or more engines, or more specifically, by one or more program modules forming part of such engine(s). A program module—which may itself contain or be a collection of one or more sub-modules—may include computer-executable instructions that when executed by a processing circuit may cause one or more operations to be performed. A processing circuit may include one or more processing units or nodes. Computer-executable instructions may include computer-executable program code that when executed by a processing unit may cause input data contained in or referenced by the computer-executable program code to be accessed and processed to yield output data. Any program module described herein may be implemented in any combination of software, hardware, and/or firmware.

Referring first to FIG. 1, a price mechanism optimization system 104 is depicted that includes a clustering engine 110, a forecasting engine 114, an optimization engine 118, and a price mechanism determination engine 120. The price mechanism optimization system 104 may be configured to read from and write to one or more data stores 106. The price mechanism optimization system 104 may be configured to implement the method 200 of FIG. 2.

Referring now to FIGS. 1 and 2 in conjunction with one another, at block 202, computer-executable instructions of the clustering engine 110 may be executed to cause a clustering algorithm to be executed to segment buyers into different buyer segments 112 with respect to one or more segmentation parameters. The clustering algorithm may be, for example, a hierarchical clustering algorithm. Buyers segmented into a same buyer segment 112 may exhibit shared attributes with respect to one or more segmentation parameters.

The segmentation parameters may include, without limitation, a pricing mechanism (e.g., spot market pricing, fixed contract pricing, formula-based pricing, etc.); product features; firmographic attributes (e.g., market share controlled by the buyer, size of the buyer in terms of market capitalization or some other metric, industry of the buyer, etc.); and so forth. Data related to the segmentation parameter(s) may be accessed from the data store(s) 106. Such data may include, without limitation, customer relationship management (CRM) data, historical request for quote (RFQ) data, supply chain data, external market data (e.g., credit rating data, import/export data, etc.), and so forth.

Buyers segmented into the same buyer segment 112 may be presumed to react in a similar manner to market price fluctuations. For example, buyers segmented into the same buyer segment 112 may be similarly inclined to turn to the spot market for fulfilling a desired amount of a product based on various types of fluctuations in the spot market price.

In addition to clustering buyers into different buyer segments, the clustering engine 110 may further determine different product segments based on various product attributes such as, for example, the industry to which a product relates, the type of product, etc. In certain example embodiments, the clustering engine 110 may also segment historical price quotes based on the type of price mechanism, based on a product feature, and/or a firmographic attribute. The various types of segmentation described above may be used to determine an appropriate set of models to use for a given buyer segment, product segment, etc. in order to jointly optimize multiple price mechanisms. The types of models that may be generated will be described hereinafter in more detail. More specifically, the operations at blocks 204-208 may be performed to generate a set of models 116 that may together be used to jointly optimize one or more parameters of multiple price mechanisms.

At block 204, computer-executable instructions of the forecasting engine 114 may be executed to forecast one or more market environment variables over a time horizon including a plurality of time periods. More specifically, the forecasting engine 114 may generate an environment forecasting model 116 at block 204 that jointly learns the dynamics of demand influencers used to predict spot market, short-term, and long-term demand. For example, if a given environment variable for a current time period is represented as xₜ, then the corresponding forecasted environment variables for subsequent time periods may be represented as xₜ₊₁, xₜ₊₂, . . . , Xₜ₊ₙ, where n may be determined based on the time period increments over which the forecasting is performed. For instance, if the environment variable is forecast on weekly time increments over the course of three months, n may equal 12. Without loss of generality, xₜ could be a vector that represents a set of environment variables. Similarly, in certain example embodiments, a spot market price may be forecasted over the time horizon including the plurality of time periods. As a non-limiting example, a current spot market price at time t and subsequent forecasted weekly spot market prices over the course of a three month period may be represented as follows: p^{s}ₜ, p^{s}ₜ₊₁, p^{s}ₜ₊₂, . . . , p^{s}ₜ₊ₙ.

At block 206, computer-executable instructions of the forecasting engine 114 may be executed to generate a demand forecast model 116 that forecasts, based at least in part on the one or more forecasted market environment variables, a respective demand for a product for each of plurality of price mechanisms across the buyer segments 112. More specifically, the demand forecast model may be used to determine a demand function for each type of price mechanism and to forecast demand out over a time horizon using the demand functions.

For example, the demand function for the spot market price mechanism may be given by the following formula:

$${\sum }_{i = 1}^{{N}_{s}} {D}_{it}^{s} ( {x}_{t} , {p}_{t}^{s} ) + {\sum }_{i = 1}^{{N}^{w}} {D}_{it}^{ws} ( {x}_{t} , {p}_{t}^{s} , {p}_{it}^{w} , {q}_{it}^{w} ) + {\sum }_{i = 1}^{{N}^{m}} {D}_{it}^{m s} ( {x}_{t} , … , {x}_{t + 3 ,} {p}_{t}^{s} , {p}_{it}^{m} , {q}_{it}^{m} ) + {\sum }_{i = 1}^{{N}^{q}} {D}_{it}^{q s} ( {x}_{t} , … , {x}_{t + 12 ,} {p}_{t}^{s} , {p}_{it}^{q} , {q}_{it}^{q} )$$

where

$${\sum }_{i = 1}^{{N}_{s}} {D}_{it}^{s} ( {x}_{t} , {p}_{t}^{s} )$$

may represent the cumulative demand of spot market buyers and the other terms may represent spillover spot market demand from buyers associated with fixed-price contract of various durations when the spot market price falls below the contract price. For example,

$${\sum }_{i = 1}^{{N}^{w}} {D}_{it}^{ws} ( {x}_{t} , {p}_{t}^{s} , {p}_{it}^{w} , {q}_{it}^{w} )$$

may represent the cumulative spillover demand of weekly contract buyers when p^{s}ₜ<p^{w}ᵢₜ;

$${\sum }_{i = 1}^{{N}^{m}} {D}_{it}^{m s} ( {x}_{t} , … , {x}_{t + 3 ,} {p}_{t}^{s} , {p}_{it}^{m} , {q}_{it}^{m} )$$

may represent the cumulative spillover demand of monthly contract buyers when p^{s}ₜ<p^{m}ᵢₜ; and

$${\sum }_{i = 1}^{{N}^{q}} {D}_{it}^{q s} ( {x}_{t} , … , {x}_{t + 12 ,} {p}_{t}^{s} , {p}_{it}^{q} , {q}_{it}^{q} )$$

may represent the cumulative spillover demand of quarterly contract buyers when p^{s}ₜ<p^{q}ᵢₜ.

The demand functions associated with, for example, weekly, monthly, and quarterly fixed-price contracts for a buyer i may be given by the following formulas, respectively: Dᵢₜ^{w}(xₜ, pₜ^{s}, pᵢₜ^{w}, qᵢₜ^{w})=max(qᵢₜ^{w}, dᵢₜ^{w}(xₜ, pᵢₜ^{w}))·1(pₜ^{s}≧pᵢₜ^{w})+qᵢₜ^{w}·1(pᵢₜ^{s}<pᵢₜ^{w}); Dᵢₜ^{m}(xₜ, pₜ^{s}, pᵢₜ^{m}, qᵢₜ^{m})=max(qᵢₜ^{m}, dᵢₜ^{m}(xₜ, pᵢₜ^{m}))·1(pₜ^{s}≧pᵢₜ^{m})+qᵢₜ^{m}·1(pₜ^{s}<pᵢₜ^{m}); and Dᵢₜ^{q}(xₜ, pₜ^{s}, pᵢₜ^{q}, qᵢₜ^{q})=max(qᵢₜ^{q},dᵢₜ^{q}(xₜ, pᵢₜ^{q}))·1(pₜ^{s}≧pᵢₜ^{q})+qᵢₜ^{q}·1(pₜ^{s}<pᵢₜ^{q}), where p^{s}ₜ represents the spot market price at time t; p^{w}ᵢₜ represents the weekly contract price; p^{m}ᵢₜ represents the monthly contract price; pq^{q}ᵢₜ represents the quarterly contract price; q^{w}ᵢₜ represent the minimum committed amount under the weekly contract; q^{m}ᵢₜ represents the minimum committed amount under the monthly contract; and q^{q}ᵢₜ represents the minimum committed amount under the quarterly contract. For example, D^{w}ᵢₜ is the purchase amount abide by the weekly contract at the price p^{w}ᵢₜ, for client i. If the weekly contract price (p^{w}ᵢₜ) is no more than the spot price (p^{s}ₜ), the client will not choose to obtain product from the spot market. If we let d^{w}ᵢₜ(xₜ, p^{w}ᵢₜ) be the client's unconstrained demand at the price p^{w}ᵢₜ, under the market environment xₜ, then if such unconstrained demand is less than the committed quantity, the client must purchase up to the committed quantity. Therefore, the final purchase will be max(q^{w}ᵢₜ, d^{w}ᵢₜ(xₜ, p^{w}ᵢₜ)). If the spot price is lower than the weekly contract price, the client will purchase the committed quantity at the contract price. If there is any extra demand above q^{w}ᵢₜ, denoted by D^{ws}ᵢₜ(xₜ, p^{s}ₜ, p^{w}ᵢₜ, q^{w}ᵢₜ), it will spill over to the spot market at a price p^{s}ₜ.

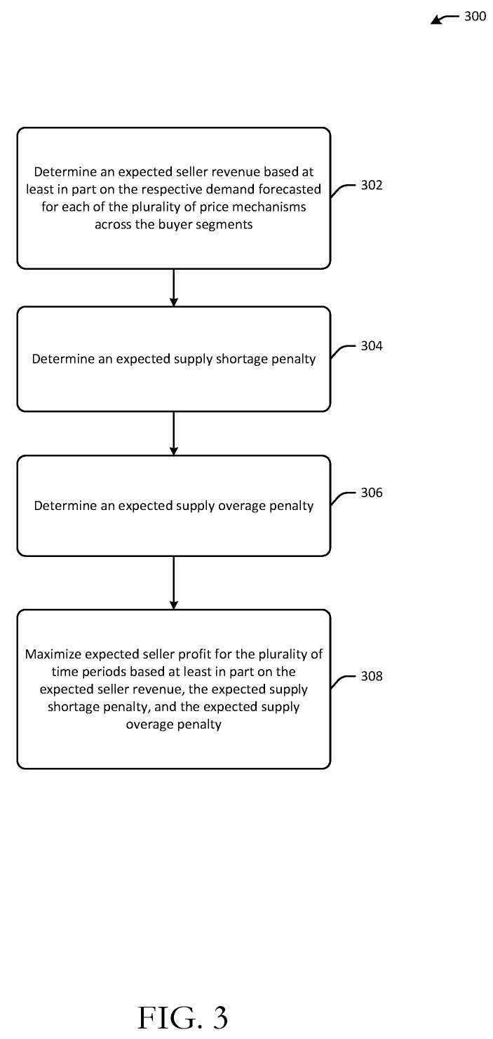

At block 208, computer-executable instructions of the optimization engine 118 may be executed to jointly optimize one or more parameters for each of the plurality of price mechanisms based at least in part on the respective forecasted demand associated with each of the price mechanisms. For example, the optimization engine 118 may jointly optimize a respective price) for each of the plurality of price mechanisms and a respective committed quantity for each of the contract-based price mechanisms based at least in part on the environment forecasting model and the demand forecast model. The joint optimization performed at block 208 will be described in more detail later in this disclosure in reference to FIG. 3.

At block 210, computer-executable instructions of the price mechanism optimization engine 120 may be executed to associate a particular type of price mechanism with a buyer 102 based at least in part on prior purchase history associated with the buyer 102. For instance, the price mechanism optimization system 104 may receive inputs relating a quote request 108 associated with the buyer 102, and the price mechanism determination engine 120 may select a particular price mechanism 122 to offer to the buyer 102. Because various parameters have been optimized across all price mechanisms offered to all buyers, the particular price mechanism 122 offered to the buyer 102 mitigates the likelihood that the buyer 102 will switch to a different price mechanism and maximizes expected profit for the seller across all buyers and all price mechanisms.

FIG. 3 is a process flow diagram of a more detailed method 300 for jointly optimizing a plurality of price mechanisms in accordance with one or more example embodiments of the disclosure. FIG. 3 will be described hereinafter in conjunction with FIG. 1.

At block 302, computer-executable instructions of the optimization engine 118 may be executed to determine a seller's expected revenue based at least in part on the respective demand forecasted for each of the plurality of price mechanisms across the buyer segments 112. The seller's revenue may include excepted revenue from demand associated with spot market buyers, expected revenue from spillover demand associated with contract buyers for contracts of various durations (e.g., weekly, monthly, quarterly, etc.), and expected revenue from product obtained by contract buyers under their respective contracts of various durations. In certain example embodiments, the seller's revenue may be represented by the following formula:

$${R}_{t} = {p}_{t}^{s} \{ {\sum }_{i = 1}^{{N}_{s}} {D}_{it}^{s} + {\sum }_{i = 1}^{{N}^{w}} {D}_{it}^{ws} + {\sum }_{i = 1}^{{N}^{m}} {D}_{it}^{m s} + {\sum }_{i = 1}^{{N}^{q}} {D}_{it}^{q s} \} + {\sum }_{i = 1}^{{N}^{w}} {p}_{it}^{w} {D}_{it}^{w} + {\sum }_{i = 1}^{{N}^{m}} {p}_{it}^{m} {D}_{it}^{m} + {\sum }_{i = 1}^{{N}^{q}} {p}_{it}^{q} {D}_{it}^{q} .$$

At block 304, computer-executable instructions of the optimization engine 118 may be executed to determine an expected supply shortage penalty. Further, at block 306, computer-executable instructions of the optimization engine 118 may be executed to determine an expected supply overage penalty. Both the expected supply shortage penalty and the expected supply overage penalty may represent penalties to the seller that are associated with a mismatch between supply and demand of the product.

The total supply of the product may be represented by yₜ and may include a spot market supply component y^{s}ₜ; a weekly contract supply component y^{w}ᵢₜ; a monthly contract supply component y^{m}ᵢₜ; and a quarterly contract supply component y^{q}ᵢₜ. A constraint may be applied to the total supply yₜ that specifies that the total supply yₜ should be no less than the inventory of the product Iₜ and no more than the total production capacity Kₜ. The constraint may be represented as follows:

$${I}_{t} \leq {y}_{t} = {y}_{t}^{s} + {\sum }_{i = 1}^{{N}^{w}} {y}_{it}^{w} + {\sum }_{i = 1}^{{N}^{m}} {y}_{it}^{m} + {\sum }_{i = 1}^{{N}^{q}} {y}_{it}^{q} \leq {K}_{t} .$$

The total manufacturing cost with a variable cost for each unit of new supply c may then be represented as: cₜ(yₜ-Iₜ). The expected supply shortage penalty with a penalty cost for each unit of backlog b may then be represented as:

$${H}_{t}^{b} = {b}_{t}^{s} {\{ {\sum }_{i = 1}^{{N}_{s}} {D}_{it}^{s} + {\sum }_{i = 1}^{{N}^{w}} {D}_{it}^{ws} + {\sum }_{i = 1}^{{N}^{m}} {D}_{it}^{m s} + {\sum }_{i = 1}^{{N}^{q}} {D}_{it}^{q s} - {y}_{t}^{s} \}}^{+} + {\sum }_{i = 1}^{{N}^{w}} {b}_{it}^{w} {\{ {D}_{it}^{w} - {y}_{it}^{w} \}}^{+} + {\sum }_{i = 1}^{{N}^{m}} {b}_{it}^{m} {\{ {D}_{it}^{m} - {y}_{it}^{m} \}}^{+} + {\sum }_{i = 1}^{{N}^{q}} {b}_{it}^{q} {\{ {D}_{it}^{q} - {y}_{it}^{q} \}}^{+}$$

and the expected supply overage penalty may be represented as:

$${H}_{t}^{h} = {h}_{t} {\{ {y}_{t} - ( {\sum }_{i = 1}^{{N}_{s}} {D}_{it}^{s} + {\sum }_{i = 1}^{{N}^{w}} {D}_{it}^{ws} + {\sum }_{i = 1}^{{N}^{m}} {D}_{it}^{m s} + {\sum }_{i = 1}^{{N}^{q}} {D}_{it}^{q s} ) \}}^{+} ,$$

where {x}⁺ is defined as max{x,0}.

Finally, at block 308, computer-executable instructions of the optimization engine 118 may be executed to maximize expected seller profit for the plurality of time periods based at least in part on the expected seller revenue, the expected supply shortage penalty, and the expected supply overage penalty. More specifically, the decision variables pₜ^{s}, (pᵢₜ^{w}, qᵢₜ^{w}), (pᵢₜ^{m}, qᵢₜ^{m}), (pᵢₜ^{q}, qᵢₜ^{q}) may be jointly optimized to maximize expected profit (Gₜ(Iₜ)) where Gₜ(Iₜ) may be represented by the following dynamic program expression with a time discount factor β.

$${max}_{{p}_{t}^{s} , {p}_{it}^{w} , {q}_{it}^{w} {p}_{it}^{m} , {q}_{it}^{m} , {p}_{it}^{q} , {q}_{it}^{q}} \{ {max}_{{y}_{t}^{s} , {y}_{it}^{w} , {y}_{it}^{m} , {y}_{it}^{q}} E \{ {R}_{t} - {H}_{t}^{b} - {H}_{t}^{h} - {c}_{t} ( {y}_{t} - {I}_{t} ) + β {G}_{t + 1} ( {I}_{t + 1} ) \} \}$$

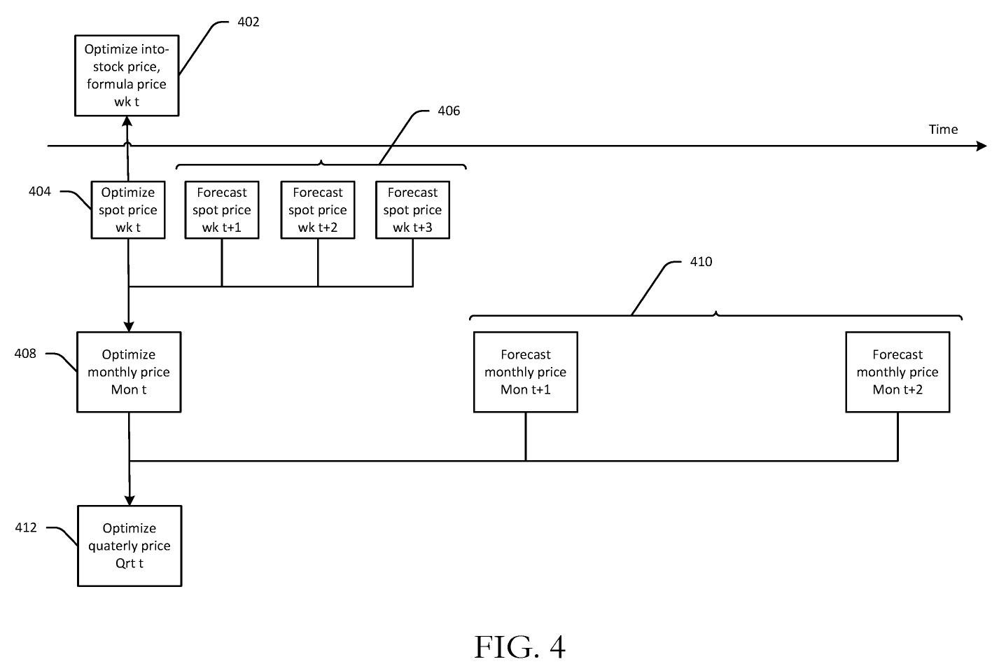

FIG. 4 is a schematic depiction of joint optimization of a plurality of price mechanisms having different time periods associated therewith in accordance with one or more example embodiments of the disclosure. FIG. 4 depicts the manner in which forecasts associated with price mechanisms of shorter durations are used to optimize price parameters of price mechanisms of longer durations as part of the joint optimization of price mechanisms described herein.

For example, at 404, a spot market price associated with week t may be optimized which may, in turn, be used at block 402 to optimize an into-stock price, a formula price, or the like associated with week t. The optimized spot market price associated with week t along with forecasted spot market prices 406 for three subsequent weeks may then be used to optimize 408 a price of a monthly price contract. Similarly, monthly prices may be forecasted 410 for subsequent months in the quarter, and used, along with the optimized price for the monthly contract at time t to optimize 412 a price of a quarterly contract at week t.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

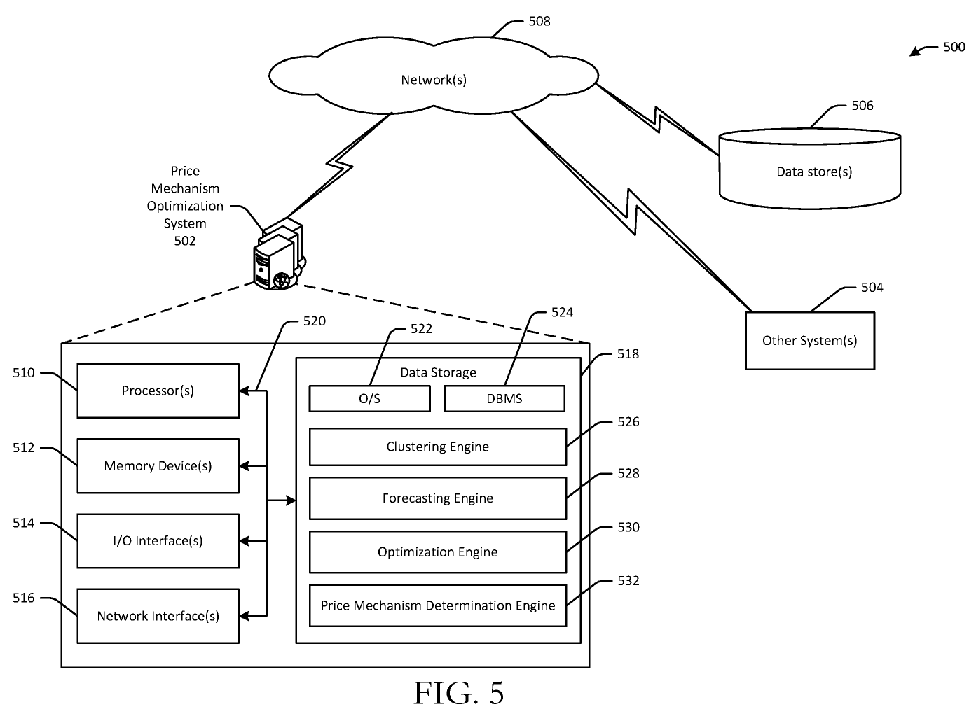

FIG. 5 is a schematic diagram of an illustrative networked architecture 500 in accordance with one or more example embodiments of the disclosure in accordance with one or more example embodiments of the disclosure. The networked architecture 500 may include a price mechanism optimization system 502 that may include one or more price mechanism optimization servers. The price mechanism optimization system 502 may be configured to communicate with one or more other systems 504 via one or more networks 508. The other system(s) 504 may include, for example, a CRM system, a historical sales/price quote system, a supply chain data system, an external market system, or the like. In addition, the price mechanism optimization system 502 may be configured to access one or more data stores 506 over the network(s) 508. The data store(s) 506 may include any of the data previously described in connection with the data store(s) 106, special pricing rules, or the like. It should be appreciated that functionality described in connection with the price mechanism optimization system 502 may be distributed across multiple price mechanism optimization servers in a distributed fashion.

The network(s) 508 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 508 may have any suitable communication range associated therewith and may include, for example, global networks (e.g., the Internet), metropolitan area networks (MANs), wide area networks (WANs), local area networks (LANs), or personal area networks (PANs). In addition, the network(s) 508 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the price mechanism optimization system 502 may include one or more processors (processor(s)) 510, one or more memory devices 512 (generically referred to herein as memory 512), one or more input/output (“I/O”) interface(s) 514, one or more network interfaces 516, and data storage 518. The price mechanism optimization system 502 may further include one or more buses 520 that functionally couple various components of the price mechanism optimization system 502.

The bus(es) 520 may include at least one of a system bus, a memory bus, an address bus, or a message bus, and may permit exchange of information (e.g., data (including computer-executable code), signaling, etc.) between various components of the price mechanism optimization system 502. The bus(es) 520 may include, without limitation, a memory bus or a memory controller, a peripheral bus, an accelerated graphics port, and so forth. The bus(es) 520 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 512 of the price mechanism optimization system 502 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 512 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 512 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 518 may include removable storage and/or non-removable storage including, but not limited to, magnetic storage, optical disk storage, and/or tape storage. The data storage 518 may provide non-volatile storage of computer-executable instructions and other data. The memory 512 and the data storage 518, removable and/or non-removable, are examples of computer-readable storage media (CRSM) as that term is used herein.

The data storage 518 may store computer-executable code, instructions, or the like that may be loadable into the memory 504 and executable by the processor(s) 510 to cause the processor(s) 510 to perform or initiate various operations. The data storage 518 may additionally store data that may be copied to memory 512 for use by the processor(s) 510 during the execution of the computer-executable instructions. Moreover, output data generated as a result of execution of the computer-executable instructions by the processor(s) 510 may be stored initially in memory 512 and may ultimately be copied to data storage 518 for non-volatile storage.

More specifically, the data storage 518 may store one or more operating systems (O/S) 522; one or more database management systems (DBMS) 524 configured to access the memory 512 and/or one or more of the data stores 506; and one or more program modules, applications, engines, computer-executable code, scripts, or the like such as, for example, a clustering engine 526, a forecasting engine 528, an optimization engine 530, and a price mechanism determination engine 532. Any of the components depicted as being stored in data storage 518 may include any combination of software, firmware, and/or hardware. The software and/or firmware may include computer-executable instructions (e.g., computer-executable program code) that may be loaded into the memory 512 for execution by one or more of the processor(s) 510 to perform any of the operations described earlier in connection with correspondingly named modules.

Although not depicted in FIG. 5, the data storage 518 may further store various types of data utilized by components of the price mechanism optimization system 502 including any of the data previously described as retrieved from the data store(s) 106 and/or the data store(s) 506. Any data stored in the data storage 518 may be loaded into the memory 512 for use by the processor(s) 510 in executing computer-executable instructions. In addition, any data stored in the data storage 518 may potentially be stored in one or more external data stores (e.g., one or more of the data stores 506) and may be accessed via the DBMS 524 and loaded in the memory 512 for use by the processor(s) 510 in executing computer-executable instructions.

The processor(s) 510 may be configured to access the memory 512 and execute computer-executable instructions loaded therein. For example, the processor(s) 510 may be configured to execute computer-executable instructions of the various program modules, applications, engines, or the like of the price mechanism optimization system 502 to cause or facilitate various operations to be performed in accordance with one or more embodiments of the disclosure. The processor(s) 510 may include any suitable processing unit capable of accepting data as input, processing the input data in accordance with stored computer-executable instructions, and generating output data. The processor(s) 510 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 510 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 510 may be capable of supporting any of a variety of instruction sets.

Referring now to other illustrative components depicted as being stored in the data storage 518, the O/S 522 may be loaded from the data storage 518 into the memory 512 and may provide an interface between other application software executing on the price mechanism optimization system 502 and hardware resources of the price mechanism optimization system 502. More specifically, the O/S 522 may include a set of computer-executable instructions for managing hardware resources of the price mechanism optimization system 502 and for providing common services to other application programs (e.g., managing memory allocation among various application programs). In certain example embodiments, the O/S 522 may control execution of one or more of the program modules depicted as being stored in the data storage 518. The O/S 522 may include any operating system now known or which may be developed in the future including, but not limited to, any server operating system, any mainframe operating system, or any other proprietary or non-proprietary operating system.

The DBMS 524 may be loaded into the memory 512 and may support functionality for accessing, retrieving, storing, and/or manipulating data stored in the memory 512, data stored in the data storage 518, and/or data stored in the data store(s) 506. The DBMS 524 may use any of a variety of database models (e.g., relational model, object model, etc.) and may support any of a variety of query languages. The DBMS 524 may access data represented in one or more data schemas and stored in any suitable data repository. The data store(s) 506 that may be accessible by the price mechanism optimization system 502 via the DBMS 524 may include, but are not limited to, databases (e.g., relational, object-oriented, etc.), file systems, flat files, distributed datastores in which data is stored on more than one node of a computer network, peer-to-peer network datastores, or the like. The data store(s) 506 may store various types of data including, without limitation, any of the types of data previously described. It should be appreciated that, in certain example embodiments, any external data store and/or any of the data residing thereon may additionally, or alternatively, be stored locally in the data storage 518.

Referring now to other illustrative components of the price mechanism optimization system 502, the input/output (I/O) interface(s) 514 may facilitate the receipt of input information by the price mechanism optimization system 502 from one or more I/O devices as well as the output of information from the price mechanism optimization system 502 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the price mechanism optimization system 502 or may be separate. The I/O devices may further include, for example, any number of peripheral devices such as data storage devices, printing devices, and so forth.

The I/O interface(s) 514 may also include an interface for an external peripheral device connection such as universal serial bus (USB), FireWire, Thunderbolt, Ethernet port or other connection protocol that may connect to one or more networks. The I/O interface(s) 514 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The price mechanism optimization system 502 may further include one or more network interfaces 516 via which the price mechanism optimization system 502 may communicate with any of the other system(s) 504 including any platforms, networks, devices, and so forth. The network interface(s) 516 may enable communication, for example, with the other system(s) 504 via one or more of the network(s) 508.

It should be appreciated that the engines depicted in FIG. 5 as being stored in the data storage 518 are merely illustrative and not exhaustive and that processing described as being supported by any particular module may alternatively be distributed across multiple engines, modules, or the like, or performed by a different engine, module, or the like. In addition, various program module(s), script(s), plug-in(s), Application Programming Interface(s) (API(s)), or any other suitable computer-executable code hosted locally on the price mechanism optimization system 502 and/or hosted on other computing device(s) accessible via one or more of the network(s) 508, may be provided to support functionality provided by the modules depicted in FIG. 5 and/or additional or alternate functionality. Further, functionality may be modularized differently such that processing described as being supported collectively by a collection of modules depicted in FIG. 5 may be performed by a fewer or greater number of program modules, or functionality described as being supported by any particular module may be supported, at least in part, by another module. In addition, engines that support the functionality described herein may form part of one or more applications executable across any number of computing devices of the price mechanism optimization system 502 in accordance with any suitable computing model such as, for example, a client-server model, a peer-to-peer model, and so forth. In addition, any of the functionality described as being supported by any of the modules depicted in FIG. 5 may be implemented, at least partially, in hardware and/or firmware across any number of devices.

It should further be appreciated that the price mechanism optimization system 502 may include alternate and/or additional hardware, software, or firmware components beyond those described or depicted without departing from the scope of the disclosure. More particularly, it should be appreciated that software, firmware, or hardware components depicted as forming part of the price mechanism optimization system 502 are merely illustrative and that some components may not be present or additional components may be provided in various embodiments. While various illustrative modules have been depicted and described as software modules stored in data storage 518, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality.

One or more operations of the methods 200 and/or 300 may be performed by a price mechanism optimization system 502 having the illustrative configuration depicted in FIG. 5, or more specifically, by one or more program modules, engines, applications, or the like executable on such a device. It should be appreciated, however, that such operations may be implemented in connection with numerous other device configurations.

The operations described and depicted in the illustrative method 200 of FIG. 2 and/or the illustrative method 300 of FIG. 3 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 2 and/or FIG. 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for jointly optimizing a plurality of price mechanisms, the method comprising:
receiving, from a buyer, a quote request for purchase of a product from a seller;
forecasting a first demand for the product for a first price mechanism of the plurality of price mechanisms;
forecasting a second demand for the product for a second price mechanism of the plurality of price mechanisms that is different from the first price mechanism; and
jointly optimizing a first one or more parameters of the first price mechanism and a second one or more parameters of the second price mechanism based at least in part on the first demand and the second demand.

2. The computer-implemented method of claim 1, further comprising:
determining a prior purchase history associated with the buyer; and
associating one of the first price mechanism or the second price mechanism with the buyer based at least in part on the prior purchase history.

3. The computer-implemented method of claim 1, further comprising:
forecasting one or more marketing environment variables over a time horizon including a current time period and one or more future time periods.

4. The computer-implemented method of claim 1, wherein the first price mechanism and the second price mechanism are associated with different durations.

5. The computer-implemented method of claim 1, wherein forecasting the first demand comprises:
determining a demand function associated with the first price mechanism; and
determining a respective value of the demand function for each of one or more future time periods.

6. The computer-implemented method of claim 1, wherein the jointly optimizing comprises:
determining an expected seller revenue for the product based at least in part on the first demand and the second demand;
determining an expected supply shortage penalty;
determining an expected supply overage penalty; and
maximizing expected seller profit for a plurality of time periods based at least in part on the expected seller revenue, the expected supply shortage penalty, and the expected supply overage penalty.

7. The computer-implemented method of claim 1, wherein the first price mechanism is associated with a first duration and the second price mechanism is associated with a second duration longer than the first duration, and wherein the jointly optimizing comprises:
determining an optimized price and a forecasted price associated with the first price mechanism; and
optimizing a price associated with the second price mechanism based at least in part on the optimized price and the forecasted price associated with the first price mechanism.

8. A system for jointly optimizing a plurality of price mechanisms, the system comprising:
at least one memory storing computer-executable instructions; and
at least one processor configured to access the at least one memory and execute the computer-executable instructions to:
receive, from a buyer, a quote request for purchase of a product from a seller;
forecast a first demand for the product for a first price mechanism of the plurality of price mechanisms;
forecast a second demand for the product for a second price mechanism of the plurality of price mechanisms that is different from the first price mechanism; and
jointly optimize a first one or more parameters of the first price mechanism and a second one or more parameters of the second price mechanism based at least in part on the first demand and the second demand.

9. The system of claim 8, wherein the at least one processor is further configured to execute the computer-executable instructions to:
determine a prior purchase history associated with the buyer; and
associate one of the first price mechanism or the second price mechanism with the buyer based at least in part on the prior purchase history.

10. The system of claim 8, wherein the at least one processor is further configured to execute the computer-executable instructions to:
forecast one or more marketing environment variables over a time horizon including a current time period and one or more future time periods.

11. The system of claim 8, wherein the first price mechanism and the second price mechanism are associated with different durations.

12. The system of claim 8, wherein the at least one processor is configured to forecast the first demand by executing the computer-executable instructions to:
determine a demand function associated with the first price mechanism; and
determine a respective value of the demand function for each of one or more future time periods.

13. The system of claim 8, wherein the at least one processor is configured to jointly optimized by executing the computer-executable instructions to:
determine an expected seller revenue for the product based at least in part on the first demand and the second demand;
determine an expected supply shortage penalty;
determine an expected supply overage penalty; and
maximize expected seller profit for a plurality of time periods based at least in part on the expected seller revenue, the expected supply shortage penalty, and the expected supply overage penalty.

14. The system of claim 8, wherein the first price mechanism is associated with a first duration and the second price mechanism is associated with a second duration longer than the first duration, and wherein the at least one processor is configured to jointly optimize by executing the computer-executable instructions to:
determine an optimized price and a forecasted price associated with the first price mechanism; and
optimize a price associated with the second price mechanism based at least in part on the optimized price and the forecasted price associated with the first price mechanism.

15. A computer program product for jointly optimizing a plurality of price mechanisms, the computer program product comprising a non-transitory storage medium readable by a processing circuit, the storage medium storing instructions executable by the processing circuit to cause a method to be performed, the method comprising:
receiving, from a buyer, a quote request for purchase of a product from a seller;
forecasting a first demand for the product for a first price mechanism of the plurality of price mechanisms;
forecasting a second demand for the product for a second price mechanism of the plurality of price mechanisms that is different from the first price mechanism; and
jointly optimizing a first one or more parameters of the first price mechanism and a second one or more parameters of the second price mechanism based at least in part on the first demand and the second demand.

16. The computer program product of claim 15, the method further comprising:
determining a prior purchase history associated with the buyer; and
associating one of the first price mechanism or the second price mechanism with the buyer based at least in part on the prior purchase history.

17. The computer program product of claim 15, the method further comprising:
forecasting one or more marketing environment variables over a time horizon including a current time period and one or more future time periods.

18. The computer program product of claim 15, wherein forecasting the first demand comprises:
determining a demand function associated with the first price mechanism; and
determining a respective value of the demand function for each of one or more future time periods.

19. The computer program product of claim 15, wherein the jointly optimizing comprises:
determining an expected seller revenue for the product based at least in part on the first demand and the second demand;
determining an expected supply shortage penalty;
determining an expected supply overage penalty; and
maximizing expected seller profit for a plurality of time periods based at least in part on the expected seller revenue, the expected supply shortage penalty, and the expected supply overage penalty.

20. The computer program product of claim 15, wherein the first price mechanism is associated with a first duration and the second price mechanism is associated with a second duration longer than the first duration, and wherein the jointly optimizing comprises:
determining an optimized price and a forecasted price associated with the first price mechanism; and
optimizing a price associated with the second price mechanism based at least in part on the optimized price and the forecasted price associated with the first price mechanism.
